(19) United States
(12) Patent Application Publication
(10) Pub. No.: US 2005/0220678 A1
(43) Pub. Date: Oct. 6, 2005

(54) Exhaust gas clarification catalyst carrying article

(76) Inventors: Jun Fujii, Saitama (JP); Kazunori Suzuki, Saitama (JP); Kiyoshi Kano, Saitama (JP)

Correspondence Address: Kent E Baldauf, 700 Koppers Building, 436 Seventh Avenue, Pittsburgh, PA, 15219-1818, US

(21) Appl. No.: 10/519,584

(22) PCT Filed: Jul. 1, 2003
(86) PCT No.: PCT/JP03/08339

§ 371 Date: Dec. 27, 2004

(30) Foreign Application Priority Data
Jul. 2, 2002 (JP) 2002-193666

(51) Int. Cl. B01D 53/34

(52) U.S. Cl. 422/177; 422/180; 422/171

(57) ABSTRACT

The exhaust gas purifying catalyst-supported member comprises a metal carrier layer and a catalyst layer which includes an exhaust gas purifying catalyst and silicon oxide and is directly formed on a surface of the metal carrier. Silicon oxide is contained in the catalyst layer, and therefore, the adhesion of the catalyst layer to the surface of the metal carrier is excellent, so that the catalyst layer resists peeling from the metal carrier even when subjected to oscillations, such as when the exhaust gas purifying catalyst-supported member is used as a catalyst for purifying an exhaust gas from, for example, an internal combustion engine.

### TECHINICAL FIELD

The present invention relates to a catalyst-supported member in which a catalyst for purifying an exhaust gas exhausted from an internal combustion engine is supported. More particularly, the invention relates to an exhaust gas purifying catalyst-supported member in which a catalyst layer hardly peels off from a surface of a metal substrate carrier.

### BACKGROUND ART

In an exhaust gas exhausted from internal combustion engines of automobiles or the like, carbon monoxide, incomplete combustion hydrocarbon, nitrogen oxide, etc. are contained, and from the viewpoint of environmental protection, decrease of quantities of these substances is desired. To purify such an exhaust gas, a method of bringing the exhaust gas into contact with a catalyst to reduce the harmful gas is known. As the catalyst, a noble metal, such as platinum, palladium or rhodium, is effective, and a catalyst-supported member for the exhaust gas wherein such a noble metal catalyst is laminated onto a surface of a carrier such as a stainless steel carrier has been employed.

The catalyst-supported member is loaded on an exhaust pipe from an internal combustion engine of an automobile or the like. In the catalyst-supported member, therefore, there is a problem that a catalyst layer laminated on the carrier surface is liable to peel off because oscillations are given to the loaded catalyst-supported member whenever the automobile is driven. That is to say, the catalyst layer is liable to peel off from the carrier in a short period of time, and the effect of the catalyst-supported member is liable to be lost.

For example, claim 1 of National Publication of International Patent No. 524018/2001 discloses an invention of “an article comprising a metal substrate having a substrate surface comprising at least one metal oxide selected from the group consisting of alumina and rare earth metal oxides; a catalyst comprising at least one catalyst layer having an outer catalyst layer surface, the catalyst layer supported on the substrate surface; the catalyst comprising at least one catalytically active particulate material, wherein the catalyst layer comprises at least two strata and the outer catalyst layer surface comprises agglomerates of the catalytically active particulate material”. Also in the article (metal plate having catalytic action) disclosed in this publication, however, a layer composed of alumina or an oxide of a rare earth metal is formed on the surface of the metal substrate, and on this layer, two catalyst layers are further formed. Also in the metal plate having catalytic action, there is a problem that the catalyst layer peels off when oscillations are continuously given to the catalyst layer.

### DISCLOSURE OF THE INVENTION

It is an object of the present invention to provide a catalyst-supported member for purifying an exhaust gas from an internal combustion engine of an automobile having a diesel engine or a gasoline engine.

It is another object of the present invention to provide an exhaust gas purifying catalyst-supported member, which is a catalyst-supported member for purifying an exhaust gas from an internal combustion engine of an automobile or the like, hardly suffers peeling of the catalyst layer and hardly loses a catalytic effect.

The exhaust gas purifying catalyst-supported member of the present invention comprises a metal carrier and a catalyst layer directly formed on a surface of the metal carrier, said catalyst layer comprising an exhaust gas purifying catalyst and silicon oxide.

That is to say, in the exhaust gas purifying catalyst-supported member of the invention, silicon oxide is contained in the catalyst layer. The silicon oxide cannot become an exhaust gas purifying catalyst directly, but by introducing it into the catalyst layer, a binder action occurs. In the present invention, therefore, by introducing silicon oxide into the catalyst layer, adhesion between the catalyst layer and the metal carrier is improved to make it possible to arrange the catalyst layer directly on the metal carrier.

The silicon oxide does not exert a direct catalytic action on an exhaust gas as described above, but even if the silicon oxide is introduced into the catalyst layer to such an extent that the binder action occurs, the catalytic activity of the catalyst layer containing the silicon oxide is hardly lowered.

By the introduction of silicon oxide into the catalyst layer, the catalyst layer can be formed on the surface of the metal carrier directly, that is, without interposing a heat-resistant inorganic oxide layer or the like, and even if the catalyst layer is directly formed on the surface of the metal carrier, the catalytic activity is not lowered. Moreover, the catalyst layer is stably present on the surface of the metal carrier for a long period of time without peeling of the catalyst from the metal carrier. Therefore, the exhaust gas purifying catalyst-supported member of the invention functions stably for a long period of time.

### BRIEF DESCRIPTION OF THE DRAWINGS

FIG. 1 is a sectional view showing an example of a section of an exhaust gas purifying catalyst-supported member of the present invention.

FIG. 2 is a sectional view showing an example of an apparatus having a mesh filter which is an exhaust gas purifying catalyst-supported member of the present invention and is to be brought into contact with an exhaust gas from a diesel engine.

FIG. 3 is a sectional view showing an example of a section of a conventional exhaust gas purifying catalyst-supported member.

### BEST MODE FOR CARRYING OUT THE INVENTION

The exhaust gas purifying catalyst-supported member of the invention is described in detail hereinafter.

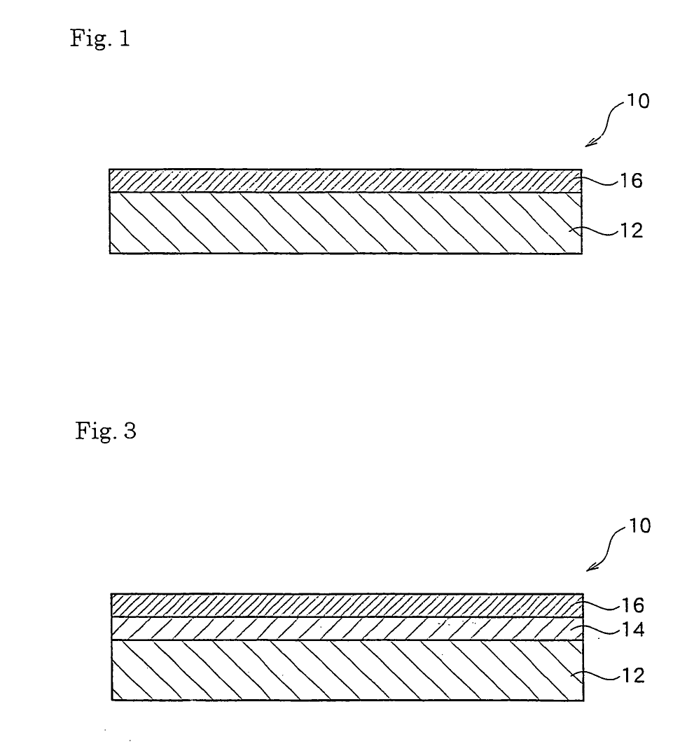

FIG. 1 shows an example of a section of an exhaust gas purifying catalyst-supported member of the invention, and FIG. 3 shows an example of a section of a conventional exhaust gas purifying catalyst-supported member. In these figures, like members are given like numerals as much as possible.

The exhaust gas purifying catalyst-supported member 10 of the invention is constituted of a metal carrier 12 and a catalyst layer 16 directly laminated onto a surface of the metal carrier 12. Between the metal carrier 12 and the catalyst layer 16 directly laminated onto the metal carrier surface, such an intermediate layer 14 as seen in the conventional exhaust gas purifying catalyst-supported member 10 is not formed.

As the metal carrier 12 to constitute the exhaust gas purifying catalyst-supported member 10 of the invention, a metal that is hardly damaged thermally and chemically by an exhaust gas from an internal combustion engine can be employed. Examples of such metals include stainless steel, nickel and titanium. Of these, heat-resistant stainless steel is preferable. There is no specific limitation on the shape of the metal carrier 12, and various shapes, such as plate, tube, honeycomb and mesh, are adoptable. In the present invention, it is particularly preferable to use a heat-resistant stainless steel punched tube or a mesh filter. The heat-resistant stainless steel punched tube or the mesh filter has excellent heat resistance, and the heat-resistant punched tube further shows very excellent exhaust gas purifying performance because it has many holes formed by punching and thereby allows the catalyst to have a large contact area with an exhaust gas. Furthermore, even when the punched tube type catalyst is arranged inside an exhaust pipe from an internal combustion engine, the resistance against the exhaust gas pressure is reduced and the burden to the internal combustion engine is small, because holes are formed.

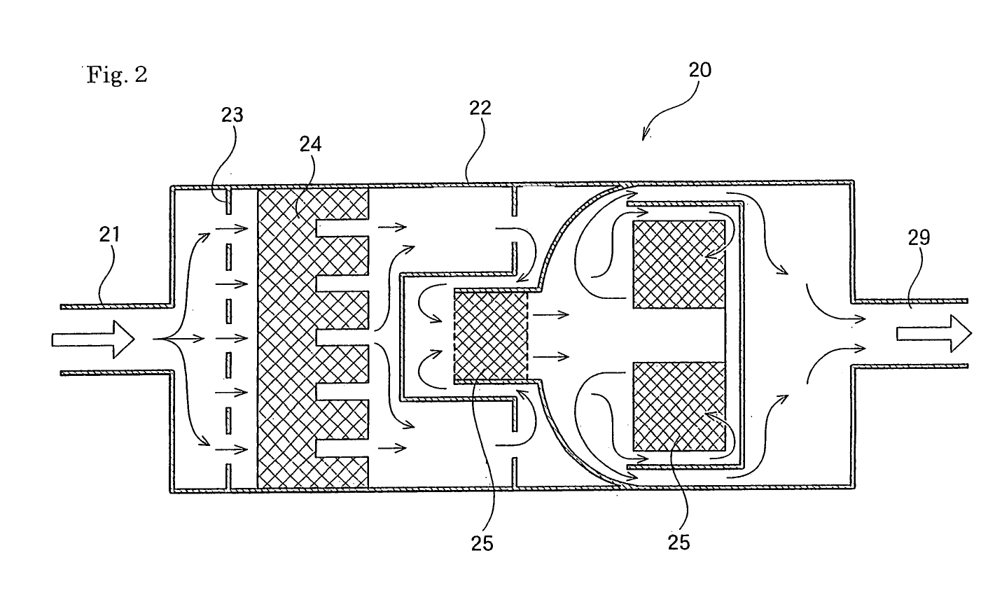

The exhaust gas purifying catalyst-supported member of the invention may be a mesh filter for treating an exhaust gas from a diesel engine or the like. In FIG. 2, an example of an exhaust gas treating apparatus in which a mesh filter for treating an exhaust gas from a diesel engine is incorporated is shown. As shown in FIG. 2, the exhaust gas treating apparatus 20 is an apparatus to treat an exhaust gas that is exhausted from a diesel engine and flows in the directions of arrows. This exhaust gas treating apparatus 20 comprises a casing 22 having an exhaust gas inlet 21 and an exhaust gas outlet 29 and comprises a rectifying plate 23, an oxidation catalyst 24 and a wire mesh filter 25 which are arranged in this order from the upstream of the flow of exhaust gas. A wire for forming the wire mesh filter 25 is the metal carrier of the exhaust gas purifying catalyst-supported member of the invention.

In the exhaust gas purifying catalyst-supported member of the invention, a catalyst layer is directly formed on a surface of the metal carrier.

The catalyst layer is formed from an exhaust gas purifying catalyst and silicon oxide.

The exhaust gas purifying catalyst comprises a noble metal and activated alumina. Examples of the noble metals employable for the exhaust gas purifying catalyst include platinum, palladium and rhodium. These noble metals can be used singly or in combination. In the present invention, it is preferable to use these noble metals in combination. For example, preferably used are combinations of platinum and rhodium, platinum and palladium, and palladium and rhodium. In case of, for example, a combination of platinum and rhodium, they are used in a mixing ratio (platinum/rhodium) of usually 20/1 to 1/1 by weight, preferably 10/1 to 1/1 by weight. By the use of platinum and rhodium in this mixing ratio, excellent gas purifying effect is exhibited.

In the catalyst layer of the catalyst-supported member of the invention, activated alumina is contained together with the novel metal. The activated alumina is a particulate substance having an average particle diameter of usually 0.1 to 200 μm, preferably 5 to 150 μm, and is a porous substance having a specific surface area of usually not less than 100 m²/g, preferably not less than 150 m²/g. The aforesaid noble metal is supported on the surface of the particulate activated alumina, and in this state, they are held on a surface of the metal carrier 12. The noble metal supported on the surface of the activated alumina has a large contact area with an exhaust gas and exhibits a high activity as the exhaust gas purifying catalyst. The weight ratio between the noble metal and the activated alumina in the exhaust gas purifying catalyst is in the range of usually 1:1 to 1:35.

In the exhaust gas purifying catalyst-supported member 10 of the invention, the catalyst layer 16 is directly formed on the surface of the metal carrier 12. As for the conventional exhaust gas purifying catalyst-supported member 10, adhesion of the catalyst layer 16 to the metal carrier 12 is not good, so that an intermediate layer 14 composed of silicon dioxide or the like is formed between the metal carrier 12 and the catalyst layer 16 to improve adhesion between the metal carrier 12 and the catalyst layer 16, as shown in FIG. 3. However, the intermediate layer 14 must be formed in a stage different from a stage for forming the catalyst layer 16, and the production process becomes complicated. Moreover, even if such an intermediate layer 14 is formed, it is difficult to say that the catalyst layer 16 adheres to the metal carrier 16 with a satisfactory strength, and when an impact caused by driving an internal combustion engine is continuously applied to the exhaust gas purifying catalyst-supported member, the catalyst layer 16 peels off.

In the present invention, it has been found that if silicon dioxide is added to the catalyst layer 16, this silicon dioxide becomes an excellent binder to stably bond the catalyst layer 16 to the metal carrier 12. The silicon dioxide, however, does not act as a catalyst for purifying an exhaust gas, so that it is necessary to determine the amount of the silicon dioxide in the catalyst layer 16 in such a range that the catalytic action of the exhaust gas purifying catalyst comprising a noble metal and activated alumina is not reduced and the adhesion properties of the catalyst layer 16 to the metal carrier 12 are sufficiently exhibited.

In the exhaust gas purifying catalyst-supported member of the invention, the weight ratio between the exhaust gas purifying catalyst and the silicon oxide in the exhaust gas purifying catalyst layer is determined in the range of usually 10:90 to 90:10′, preferably 10:90 to 40:60, more preferably 20:80 to 40:60, particularly preferably 20:80 to 30:70. By determining the amount of the silicon oxide in such a range, adhesion properties of the catalyst layer to the metal carrier can be remarkably enhanced without substantial decrease of the catalytic activity of the catalyst layer. The amount of the exhaust gas purifying catalyst means a total amount of the aforesaid noble metal and activated alumina.

The catalyst layer having such composition can be formed by various processes. For example, by a process comprising spraying a solution having the composition of the catalyst layer onto the surface of the metal carrier 12 or a process comprising depositing a catalyst layer on the surface of the metal carrier 12 by CVD (Chemical Vapor Deposition) or the like, the catalyst layer 16 can be formed directly on the surface of the metal carrier 12. Further, the catalyst layer can be also formed by a process comprising dissolving the components for forming the catalyst layer 16 in a solvent to prepare a solution or finely dispersing them in a solvent to prepare a dispersion, immersing the metal carrier 12 in the solution or the dispersion to deposit the components for forming the catalyst layer 16 on the surface of the metal carrier 12 and then heating the metal carrier having the thus deposited catalyst layer-forming components to sinter the catalyst layer-forming components.

The catalyst layer formed by depositing the catalyst layer-forming components from the solution or the dispersion and then sintering them as described above has excellent adhesion to the surface of the metal carrier, and moreover, because the catalyst layer is made porous by sintering, it has a large specific surface area and thereby exhibits excellent catalytic activity. According to the above process, further, it becomes possible to form a catalyst layer of high homogeneity wherein the catalyst layer-forming components are homogeneously dispersed.

The solution or the dispersion wherein the catalyst layer-forming components are dissolved or dispersed, which is used in the above process, is for example a nitric acid solution or a hydrochloric acid solution containing those components. The catalyst layer-forming components can be deposited on the surface of the metal carrier by changing pH of the solution or the dispersion or heating the solution or the dispersion to change a state of the solution or the dispersion. For example, the metal carrier is immersed in a nitric acid solution wherein the catalyst layer-forming components are dissolved, and the nitric acid solution is heated to a temperature of usually room temperature (usually 25° C.) to 50° C., preferably 30 to 40° C., to deposit the catalyst layer-forming components on the surface of the metal carrier. By continuously carrying out deposition for usually 1 to 24 hours, preferably 5 to 10 hours, under the above temperature conditions, the catalyst layer-forming components can be deposited in a desired thickness.

The metal carrier having the deposited catalyst layer-forming components is then calcined. The calcining temperature is in the range of usually 300 to 600° C., preferably 300 to 500° C., and the calcining time at this temperature is in the range of usually 1 to 4 hours, preferably 2 to 3 hours. Through the above calcining, a volatile component is removed from the catalyst layer, and catalytic activity is imparted to the noble metal and alumina. Further, the silicon dioxide functions as a binder to unite the metal carrier and the catalyst layer.

The average thickness of the catalyst layer formed as above is in the range of usually 5 to 100 μm, preferably 10 to 40 μm.

The exhaust gas purifying catalyst-supported member of the invention prepared as above exhibits catalytic activity almost equal to or higher than that of a conventional exhaust gas purifying catalyst-supported member having a catalyst layer that is formed on a metal carrier through an intermediate layer. As compared with a catalyst layer of the exhaust gas purifying catalyst-supported member that is prepared by the conventional process and has an intermediate layer, the catalyst layer in the invention is extremely strongly bonded to the metal carrier, and when the exhaust gas purifying catalyst-supported member of the invention is irradiated with ultrasonic waves to measure a peel ratio of the catalyst layer, the peel area of the catalyst layer is decreased to ⅕ to 1/10 the peel area of the catalyst layer of the conventional exhaust gas purifying catalyst-supported member measured after irradiation with ultrasonic waves under the same conditions. Furthermore, even when the exhaust gas purifying catalyst-supported member of the invention is loaded on an exhaust pipe for an exhaust gas from an internal combustion engine, it can be stably used for a longer period of time than the conventional exhaust gas purifying catalyst-supported member.

### INDUSTRIAL APPLICABILITY

In the exhaust gas purifying catalyst-supported member of the invention, a catalyst layer is directly formed on a surface of a metal carrier without interposing an intermediate layer. This catalyst layer is extremely strongly bonded to the surface of the metal carrier and hardly peels off even when oscillations or the like are given. The catalytic activity of the catalyst layer as the exhaust gas purifying catalyst is almost equal to or higher than that of the catalyst layer formed on the metal carrier through an intermediate layer.

The exhaust gas purifying catalyst-supported member of the invention has the above-mentioned layer structure, and its production process can be simplified.

### EXAMPLES

The present invention is further described with reference to the following examples, but it should be construed that the invention is in no way limited to those examples.

### Example 1

Holes having a diameter of 2.0 mm were punched into a heat-resistant stainless steel tube (diameter 30 mm, length: 100 mm) having a thickness of 1 mm at a pitch of 3.5 mm to prepare a punched-tube as a metal carrier.

The punched tube was immersed in a slurry containing alumina (Al₂O₃) and silicon dioxide (SiO₂) in a ratio of 30:70 (Al₂O₃:SiO₂), then taken out of the slurry and calcined. Thereafter, the punched tube was immersed in a nitric acid solution containing platinum and rhodium in a ratio of 5:1 (platinum:rhodium). The solution was heated to 40° C., and the punched tube was impregnated with the solution over a period of 16 hours so as to homogeneously distribute platinum and rhodium into the alumina/silicon dioxide.

Then, the punched tube was taken out of the solution and calcined in a heating oven at a temperature of 500° C. for 2 hours to prepare an exhaust gas purifying catalyst-supported member.

In the resulting exhaust gas purifying catalyst-supported member, platinum and rhodium were contained in a ratio of 5:1 by weight in terms of metal, and the metals (platinum+rhodium) and activated alumina were contained in a ratio of 1:6 by weight in terms of metal.

The ratio between the exhaust gas purifying catalyst and silicon oxide in the catalyst layer of the exhaust gas purifying catalyst-supported member was 35:70 by weight.

The amount of the noble metals (platinum+rhodium) in the exhaust gas purifying catalyst-supported member was 5 g/cm². The specific surface area of the activated alumina contained in the catalyst layer was 160 m²/g.

### Comparative Example 1

An exhaust gas purifying catalyst-supported member was prepared in the same manner as in Example 1, except that an undercoating layer (main component: silicon dioxide) having a thickness of 30 μm was formed on the surface of the punched tube and a catalyst layer containing no silicon dioxide was formed on the undercoating layer.

In the resulting exhaust gas purifying catalyst-supported member, platinum and rhodium were contained in a ratio of 5:1 by weight in terms of metal, and the metals (platinum+rhodium) and activated alumina were contained in a ratio of 1:6 by weight in terms of metal.

In the catalyst layer of the exhaust gas purifying catalyst-supported member, silicon oxide was not contained.

The amount of the noble metals (platinum+rhodium) in the exhaust gas purifying catalyst-supported member was 5 g/cm². The specific surface area of the activated alumina contained in the catalyst layer was 160 m²/g.

Evaluation Test

A durability test (20 hours) of the exhaust gas purifying catalyst-supported members prepared in Example 1 and Comparative Example 1 was carried out using an internal combustion engine exhaust gas of 900° C. Then, 50% purification temperatures of CO, HC and NOX were measured. As a result, the 50% purification temperatures of CO, HC and NOX in case of the exhaust gas purifying catalyst-supported member prepared in Example 1 were 280° C., 374° C. and 370° C., respectively, while the 50% purification temperatures of CO, HC and NOX in case of the exhaust gas purifying catalyst-supported member prepared in Comparative Example 1 were 284° C., 380° C. and 374° C., respectively.

Further, purification ratios of CO, HC and NOX at 400° C. were measured using an internal combustion engine exhaust gas. As a result, the 400° C. purification ratios of CO, HC and NOX in case of the exhaust gas purifying catalyst-supported member prepared in Example 1 were 50.0%, 52.0% and 54.5%, respectively, while the 400° C. purification ratios of CO, HC and NOX in case of the exhaust gas purifying catalyst-supported member prepared in Comparative Example 1 were 47.0%, 51.1% and 54.5%, respectively.

As is apparent from the comparison between these values, the catalytic action and effect of the exhaust gas purifying catalyst-supported member prepared in Example 1 are nearly equal to those of the exhaust gas purifying catalyst-supported member prepared in Comparative Example 1.

Then, to the exhaust gas purifying catalyst-supported members prepared in Example 1 and Comparative Example 1, ultrasonic waves (output power: 150 W) of 38 kHz were applied over a period of 15 minutes, and weights of the catalyst layers having peeled were measured.

As a result, the peel ratio by weight in the exhaust gas purifying catalyst-supported member prepared in Example 1 was 5.0% by weight, while the peel ratio by weight in the exhaust gas purifying catalyst-supported member prepared in Comparative Example 1 reached 37.5% by weight.

As is apparent from the results, the quantity of the catalyst layer having peeled by the external oscillations in the exhaust gas purifying catalyst-supported member prepared in Example 1 was decreased to about 1/7 the quantity of the peeled catalyst layer in the conventional exhaust gas purifying catalyst-supported member having an intermediate layer.

The results are set forth in Table 1.

### Examples 2 and 3

An exhaust gas purifying catalyst-supported member was prepared in the same manner as in Example, 1, except that the quantity ratio between the exhaust gas purifying catalyst and silicon oxide in the catalyst layer formed on the punched tube was changed to 25:80 (exhaust gas purifying catalyst:silicon dioxide (SiO₂), Example 2) or 45:60 (exhaust gas purifying catalyst:silicon dioxide (SiO₂), Example 3).

The resulting exhaust gas purifying catalyst-supported member was examined on the 400° C. purification ratios and the 50% purification temperatures in the same manner as in Example 1. Further, to the resulting exhaust gas purifying catalyst-supported member, ultrasonic waves were applied, and the weight of the catalyst layer having peeled was determined in the same manner as in Example 1.

The results are set forth in Table 1.

TABLE 1

| | | Weight ratio in | | | | |
|---|---|---|---|---|---|---|
| | | catalyst layer | | | | |
| | | Exhaust gas | Pt/Rh weight | | | |
| | Inter- | purifying | ratio in | Amount of | Amount of Al₂O₃ | (Pt + Rh)/Al₂O₃ |
| | mediate | catalyst/Silicon | catalyst | Pt + Rh | in catalyst | weight ratio in |
| | layer | oxide | layer | supported | (g/m²) | catalyst layer |
| Ex. 1 | none | 35/70 | 5/1 | 5 | 30 | 1/6 |
| Ex. 2 | none | 25/80 | 5/1 | 5 | 20 | 1/4 |
| Ex. 3 | none | 45/60 | 5/1 | 5 | 40 | 1/8 |
| Comp. | formed | 35/70^{*1)} | 5/1 | 5 | 30 | 1/6 |
| Ex. 1 | | | | | | |

| | 50% Purification | | | 400° C. Purification | | | Peel |
|---|---|---|---|---|---|---|---|
| | Temperature (° C.) | | | ratio (%) | | | ratio |
| | CO | HC | NOₓ | CO | HC | NOₓ | (wt %) |
| Ex. 1 | 280 | 374 | 370 | 50.0 | 52.0 | 54.5 | 5.0 |
| Ex. 2 | 283 | 376 | 369 | 51.0 | 51.0 | 55.3 | 3.2 |
| Ex. 3 | 277 | 374 | 365 | 53.2 | 55.0 | 56.0 | 6.5 |
| Comp. | 284 | 380 | 374 | 47.0 | 51.1 | 54.5 | 37.5 |
| Ex. 1 | | | | | | | |

Remarks
^{*1)}weight of exhaust gas purifying catalyst/weight of intermediate layer

1. An exhaust gas purifying-catalyst-supported member comprising a metal carrier and a catalyst layer directly formed on a surface of the metal carrier, said catalyst layer comprising an exhaust gas purifying catalyst and silicon oxide.

2. The exhaust gas purifying catalyst-supported member as claimed in claim 1, wherein the weight ratio between the exhaust gas purifying catalyst and silicon oxide in the catalyst layer is in the range of 10:90 to 90:10.

3. The exhaust gas purifying catalyst-supported member as claimed in claim 1, wherein the exhaust gas purifying catalyst in the catalyst layer comprises at least one noble metal selected from the group consisting of platinum, palladium and rhodium, and activated alumina.

4. The exhaust gas purifying catalyst-supported member as claimed in claim 1, wherein the metal carrier is a metal plate selected from the group consisting of a stainless steel plate, a stainless steel tube and a stainless steel corrugated plate.

5. The exhaust gas purifying catalyst-supported member as claimed in claim 3, wherein the weight ratio between the noble metal and the activated alumina in the exhaust gas purifying catalyst layer is in the range of 1:1 to 1:35.

6. The exhaust gas purifying catalyst-supported member as claimed in claim 1, which is a mesh filter brought into contact with an exhaust gas from a diesel engine.
